(19) United States
(12) Patent Application Publication
(10) Pub. No.: US 2013/0177793 A1
(43) Pub. Date: Jul. 11, 2013

(54) ASSEMBLING PALLET FOR SECONDARY BATTERY AND METHOD OF THE SECONDARY BATTERY

(71) Applicant: Tetsuo Seki, Toyota-shi (JP)

(72) Inventor: Tetsuo Seki, Toyota-shi (JP)

(21) Appl. No.: 13/318,516

(22) PCT Filed: Sep. 20, 2010
(86) PCT No.: PCT/JP2010/066264

§ 371 Date: Nov. 2, 2011

(51) Int. Cl. H01M 2/10; B23P 11/00

(52) U.S. Cl. CPC H01M 2/1072; B23P 11/00
USPC 429/99; 29/428

(57) ABSTRACT

To provide a secondary-battery assembling pallet configured to support a plurality of types of secondary batteries, a secondary-battery assembling pallet (200) for a secondary battery including end plates (101) placed on both ends of battery cells (103) arranged side by side and a lower case (110) placed on a lower part includes a primary positioning pin (201) and a secondary positioning pin (202) for positioning the end plates (101), a seat pin (203) for supporting a stack assembly (105) of the secondary battery, and a base (210). The primary positioning pin (201) is fixed to the base (210) and the secondary positioning pin (202) is movably held on the base (210).

### CROSS-REFERENCE TO RELATED APPLICATIONS

This application is a national phase application of International Application No. PCT/JP2010/066264, filed Sep. 20, 2010, the contents of which are incorporated herein by reference.

### TECHNICAL FIELD

The present invention relates to a technique for providing commonality of a pallet in an assembling process of a secondary battery, in particular, when a plurality of types of battery packs are to be manufactured in a manufacturing line of a battery pack in which both sides of a stack assembly of a secondary battery are held with end plates.

### BACKGROUND ART

In recent years, several types of vehicles such as a hybrid electric vehicle, an electric vehicle, and others, mounted with a large-capacity secondary battery, have been marketed with the view to international circumstances, environmental issues, etc. This tendency is assumed to continue and the types of vehicles mounted with larger-capacity secondary batteries are expected to increase. Therefore, more than one size of secondary batteries are also demanded. Accordingly, corresponding pallets have been required to hold such a secondary battery in a secondary battery assembling line.

Such a compact, large-capacity secondary battery as to be mounted in a vehicle has not been so much utilized. Thus, the commonality of such a pallet has been less studied so far. Under present circumstances, accordingly, one type of a pallet is used for one type of product. However, it is expected that more types of secondary batteries need to be manufactured in a single manufacturing line. Enabling the commonality of pallet is an urgent necessity.

Heretofore, the commonality of pallet has been provided in manufacturing lines for various products. Therefore, many proposals have been provided for achieving the commonality of pallet. For instance, Patent Document 1 discloses a technique related to a pallet for drying tile base material. This pallet is configured such that a plurality of receivers having supporting surfaces providing the shape substantially coinciding with the shape of a tile base material are arranged in parallel with each other and across a plurality of support rods placed in parallel with each other to support different types of tile base material made in a wet manner. In this pallet, at least one of the receivers is movable on the support rods.

Patent Document 2 discloses a technique related to a method and system using a work positioning jig. A pallet is to hold a vehicle's body and includes a frame consisting of a plurality of beams extending in a longitudinal direction and a lateral direction and coupled to each other. The pallet is provided with a pallet receiver removably attached. There are further provided a slidable positioning mechanism and a lockable jig, so that the body can be held on the pallet.

Patent Document 3 discloses a technique related to a conveying pallet. This pallet is configured to convey a compressor to be mounted on a vehicle and includes an almost-plate like base and support blocks provided in the base and formed with a plurality of receiving surfaces for supporting the compressor in contact therewith. The receiving surfaces of the support blocks are each formed in a stepped shape with different sizes from each other from the base according to the types of compressors. With such a configuration, a single pallet can be used for more than one type of compressor.

### RELATED ART DOCUMENTS

### Patent Documents

Patent Document 1: JP 8 (1996)-061857A
Patent Document 2: JP2000-176747A
Patent Document 3: JP2004-182307A

### DISCLOSURE OF THE INVENTION

### Problems to be Solved by the Invention

However, Patent Documents 1 to 3 are considered to have the following problems.

For conveying the secondary battery, the secondary battery needs to include a part to be supported by the pallet. However, the secondary battery has less contactable portions to be supported and, in particular, is hard to correspond to lower cases having different shapes according to the type of vehicle. It is therefore difficult to directly put the techniques of Patent Documents 1 to 3 into practice.

The present invention has been made to solve the above problems and has a purpose to provide an assembling pallet for a secondary battery and configured to support a plurality of types of secondary batteries, and a battery manufacturing method.

### Means of Solving the Problems

To achieve the above purpose, an assembling pallet for a secondary battery according to one aspect of the invention has the following features.

(1) In an assembling pallet for a secondary battery including end plates placed on both sides of a plurality of battery cells arranged side by side and a lower case for mounting the battery cells on a vehicle body, the pallet includes a positioning pin for positioning the end plates, a support seat for supporting the end plates and a stack assembly of the secondary battery, and a base plate, the positioning pin includes a primary positioning pin and a secondary positioning pin, the primary positioning pin is fixed to the base plate, and the secondary positioning pin is held on the base plate and configured to be movable relative to the primary positioning pin.

(2) In the secondary-battery assembling pallet set forth in (1), preferably, the primary positioning pin and the secondary positioning pin are formed in a stepped shape, each pin including a tip portion for positioning the end plates and a support part for supporting the lower case, the support part is formed with a height equal to the support seat, and the primary positioning pin, the secondary positioning pin, and the support seat are inserted and placed in the base plate.

Further, to achieve the above purpose, a method of producing a secondary battery according to another aspect of the invention has the following features.

(3) In a method of manufacturing a secondary battery by placing a lower case on an assembling pallet, and placing a stack assembly on the lower case, the stack assembly consisting of a plurality of battery cells arranged side by side and bound from both sides with end plates, and assembling the lower case and the stack assembly, the method comprises: disposing a secondary positioning pin configured to be movable relative to a primary positioning pin provided in the assembling pallet, in a position corresponding to a position of one of the end plates of the stack assembly, supporting the lower case by the primary positioning pin, secondary positioning pin, and support seat, and placing the stack assembly on the lower case and assembling the stack assembly and lower case.

### Effects of the Invention

One aspect of the secondary-battery assembling pallet according to the invention having the above features can provide operations and effects described below.

The aforementioned aspect of the invention disclosed in (1) provides an assembling pallet for a secondary battery including end plates placed on both sides of a plurality of battery cells arranged side by side and a lower case for mounting the battery cells on a vehicle body, wherein the pallet includes a positioning pin for positioning the end plates, a support seat for supporting the end plates and a stack assembly of the secondary battery, and a base plate, the positioning pin includes a primary positioning pin and a secondary positioning pin, the primary positioning pin is fixed to the base plate, and the secondary positioning pin is held on the base plate and configured to be movable relative to the primary positioning pin.

The lower case is used to mount the secondary battery on a vehicle. The shape of this lower case depends on the shape of a vehicle body or the like. Therefore, portions of the secondary battery, which are relatively easy to support, are positioned in place by the primary positioning pin and the secondary positioning pin. The secondary positioning pin is movably held. With this configuration, a single pallet for secondary battery can be used to support the different-sized stack assemblies and the different-sized lower cases.

Enabling the commonality of pallet is very advantageous to greatly reduce a burden of management of pallets in manufacturing more than one type of secondary battery in a single manufacturing line. In particular, when various types of secondary batteries are to be produced in turn through a single manufacturing line, time loss taken for replacement of pallets may deteriorate productivity. Thus, the commonality of pallet shows great significance.

The aforementioned aspect of the invention described in (2) provides the secondary-battery assembling pallet recited in (1), in which the primary positioning pin and the secondary positioning pin are formed in a stepped shape, each pin including a tip portion for positioning the end plates and a support part for supporting the lower case, the support part is formed with a height equal to the support seat, and the primary positioning pin, the secondary positioning pin, and the support seat are inserted and placed in the base plate.

The positioning pin, the secondary positioning pin, and the support seat are designed in insertable configuration, so that they can be replaced with new ones in case of wastage. Each of the primary positioning pin and the secondary positioning pin is formed in a stepped shape to provide a support part so that the primary positioning pin and the secondary positioning pin can have a function of a support seat. With this configuration, the portions that will contact with the lower case are made replaceable, which contributes to increase service life of the pallet.

Moreover, the aspect of the method of manufacturing the secondary battery according to the invention having such features can provide operations and effects described below.

The above invention set forth in (3) provides a method of manufacturing a secondary battery by placing a lower case on an assembling pallet, and placing a stack assembly on the lower case, the stack assembly consisting of a plurality of battery cells arranged side by side and bound from both sides with end plates, and assembling the lower case and the stack assembly, the method comprising: disposing a secondary positioning pin configured to be movable relative to a primary positioning pin provided in the assembling pallet, in a position corresponding to a position of one of the end plates of the stack assembly, supporting the lower case by the primary positioning pin, secondary positioning pin, and support seat, and placing the stack assembly on the lower case and assembling the stack assembly and lower case.

Since the primary positioning pin is placed movably relative to the secondary positioning pin, as above, more than one type of secondary battery can be assembled by a single type of common pallet. When such commonality of pallet is enabled, maintenance and management costs of pallets can be reduced, resulting in cost reduction of the secondary battery.

### BRIEF DESCRIPTION OF THE DRAWINGS

FIG. 1 is a perspective view of a stack assembly of a battery unit in a first embodiment;

FIG. 2 is a perspective view of a lower case in the first embodiment;

FIG. 3 is a plan view of the lower case in the first embodiment;

FIG. 4 is a side view of the lower case in the first embodiment;

FIG. 5 is a perspective view of a pallet in the first embodiment;

FIG. 6 is a perspective view showing a state where the battery unit is being assembled on the pallet in the first embodiment;

FIG. 7 is a plan view showing a state where the battery unit is placed on the pallet in the first embodiment;

FIG. 8 is a cross sectional view of a positioning pin in the first embodiment;

FIG. 9 is a perspective view of the pallet after tooling change in the first embodiment;

FIG. 10 is a perspective view of a lower case for a work B in the first embodiment;

FIG. 11 is a plan view of the lower case for the work B in the first embodiment;

FIG. 12 is a plan view showing that the battery unit is placed on the pallet in the first embodiment;

FIG. 13 is a plan view of a lower case for a work C in the first embodiment;

FIG. 14 is a plan view showing that the battery unit is placed on the pallet in the first embodiment; and

FIG. 15 is a perspective view of a pallet after tooling change in a second embodiment.

### MODE FOR CARRYING OUT THE INVENTION

A detailed description of a first preferred embodiment of the present invention will now be given.

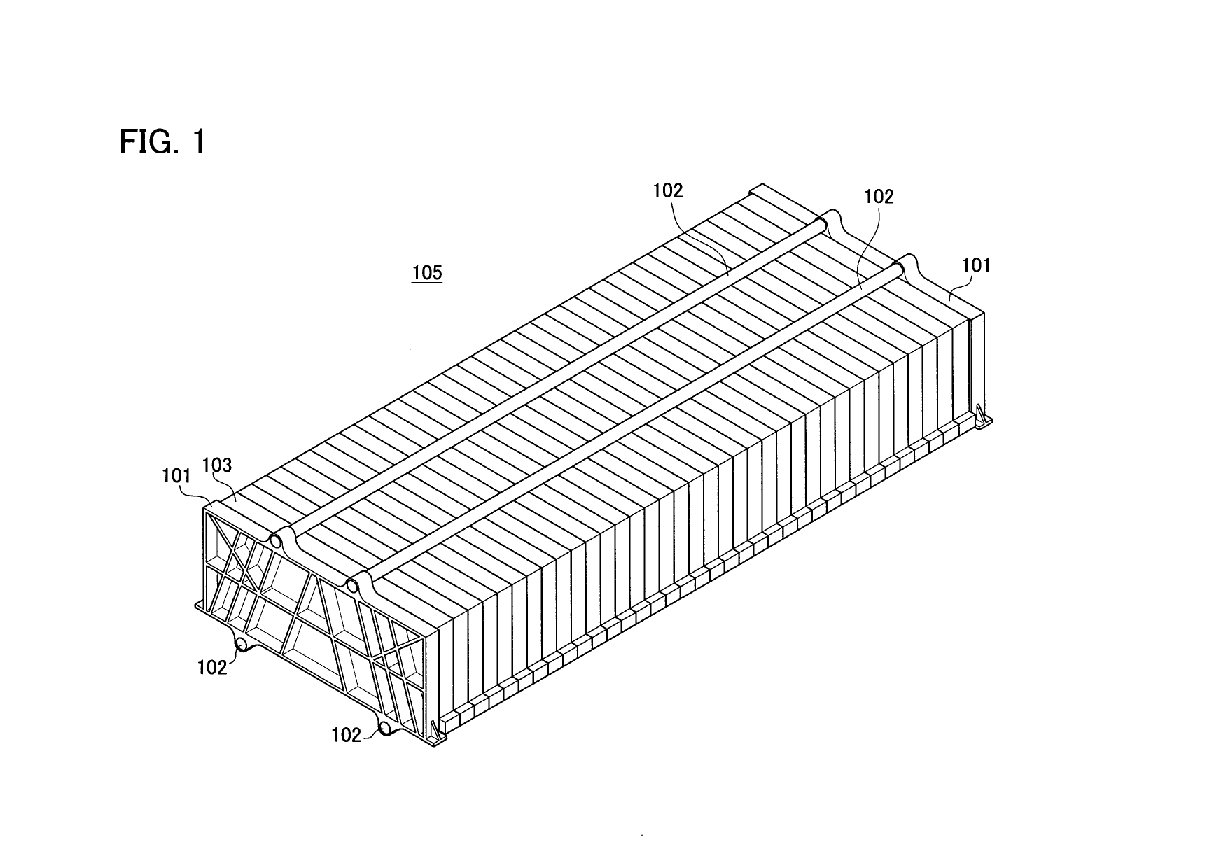

FIG. 1 is a perspective view of a stack assembly 105 of a battery unit 100 used in a first embodiment. The stack assembly 105 forming the battery unit 100 includes a plurality of battery cells 103 stacked and bound with two end plates 101 and four binding metal fittings 102. The weight of each battery cell 103 is about 1 kg. The stack assembly 105 consists of a dozen to several tens of battery cells 103. Thus, the battery unit 100 weighs several tens of kilograms. Both sides of the stacked battery cells 103 are retained by the end plates 101 and connected with four binding metal fittings 102, forming the stack assembly 105.

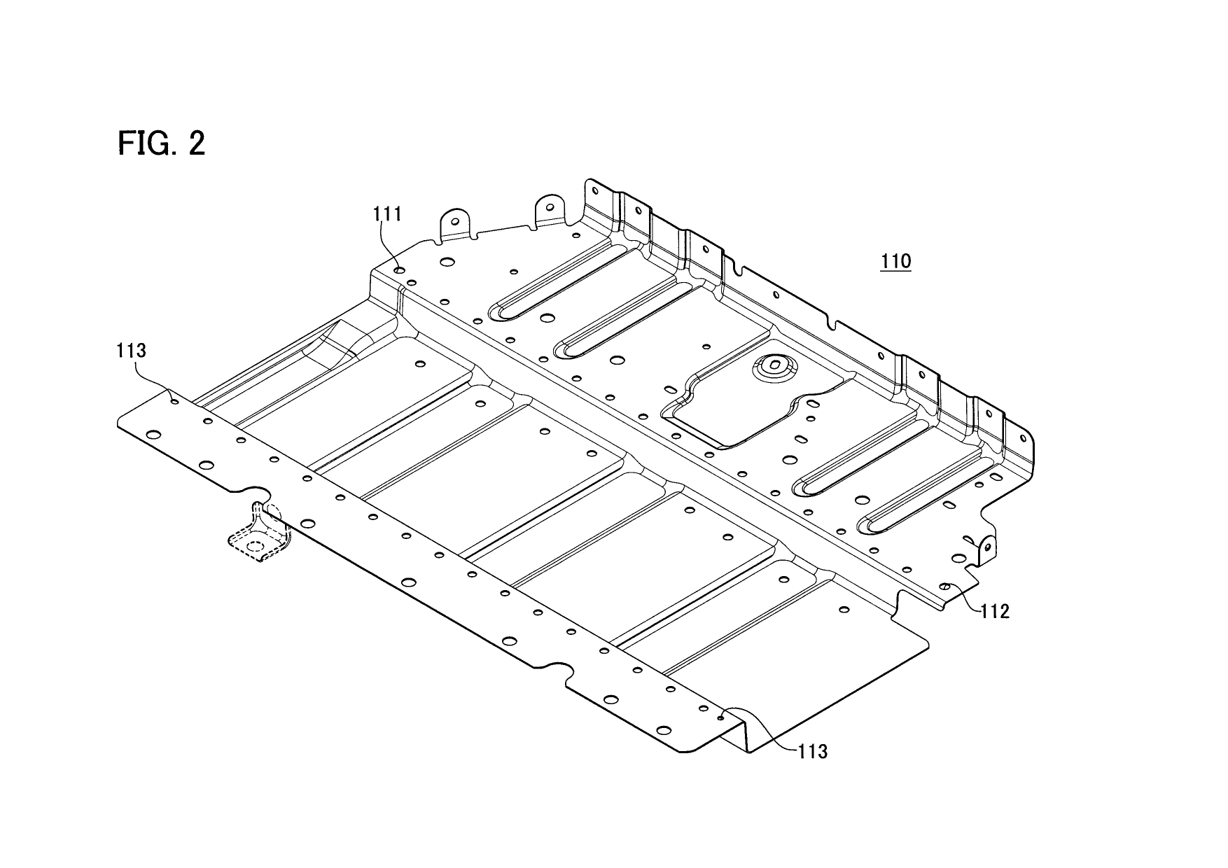

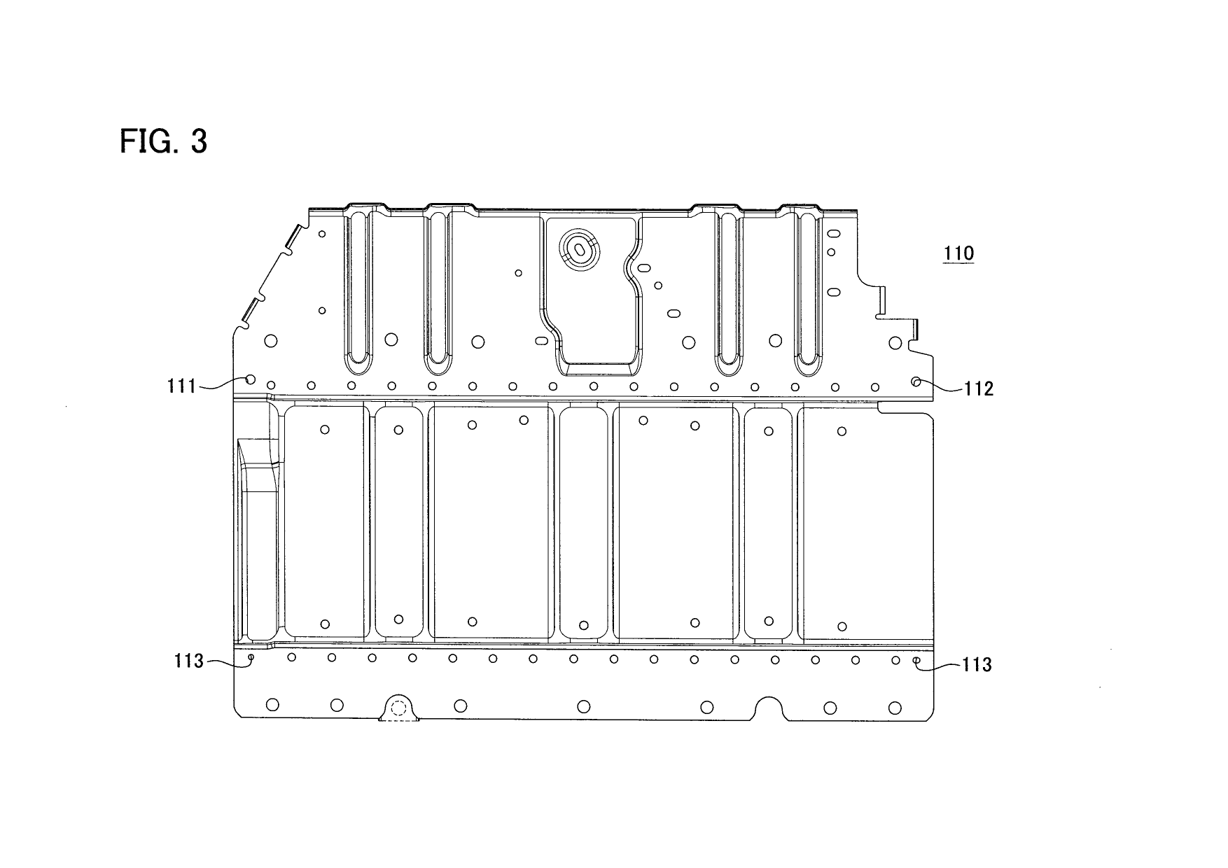

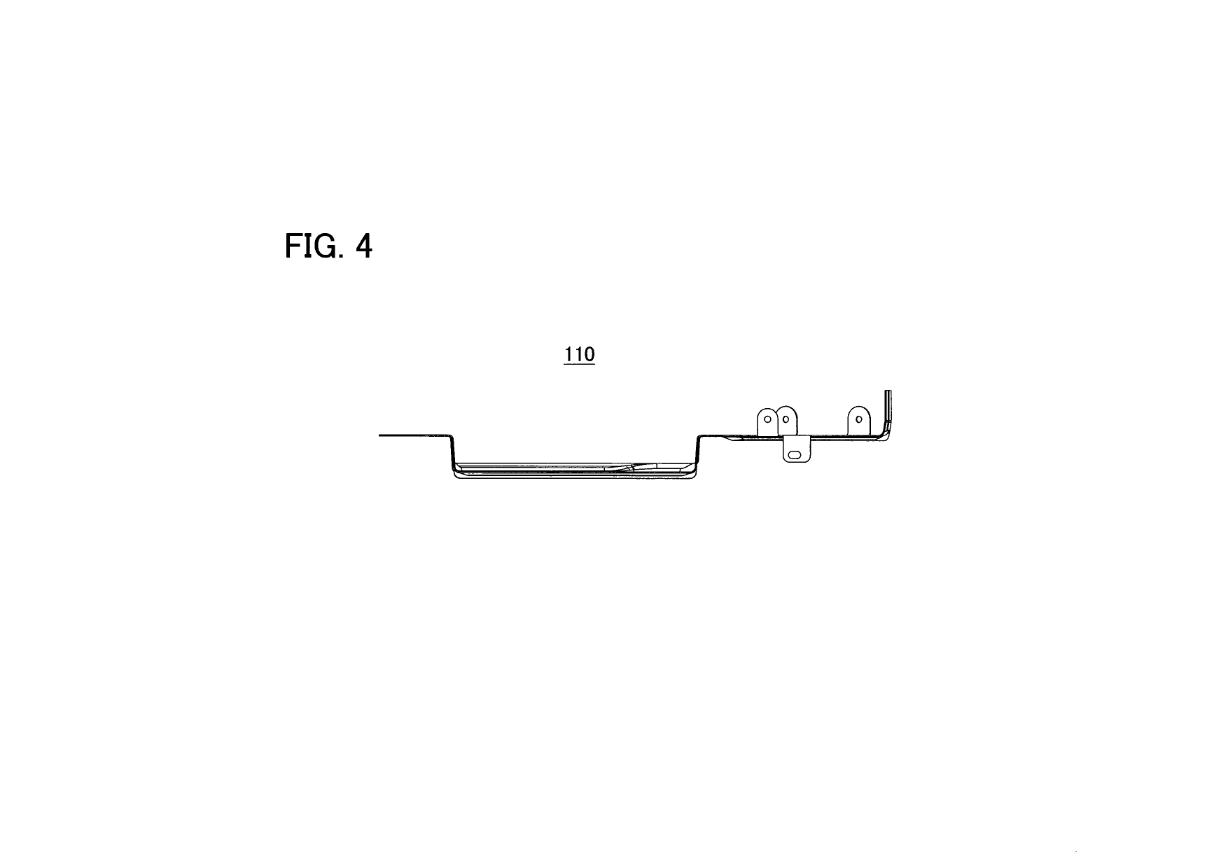

FIG. 2 is a perspective view of a lower case 110 for a work A (also referred to as a “work-A lower case”). FIG. 3 is a plan view of the lower case 110. FIG. 4 is a side view of the lower case 110. The lower case 110 is formed of a steel plate having a thickness of about 0.7 mm and pressed into such a shape as having an irregular surface. The lower case 110 is formed with a positioning hole 111 for a primary positioning pin (“a primary positioning hole”), a positioning hole 112 for a secondary positioning pin (“a secondary positioning hole”), and two dowel holes 113. The shape of the lower case 110 depends on the type of a vehicle on which the battery unit 100 is to be mounted. The battery unit 100 is often placed in a vehicle not shown along a vehicle body, e.g., under a rear seat or a baggage room. In such cases, the battery unit 100 needs to be attached around the body or components belonging to the body. Thus, the lower case 110 is apt to have a complicated shape. The primary positioning hole 111 and the secondary positioning hole 112 are respectively designed with a diameter of 9 mm and each dowel hole 113 is designed with a diameter of 5.2 mm.

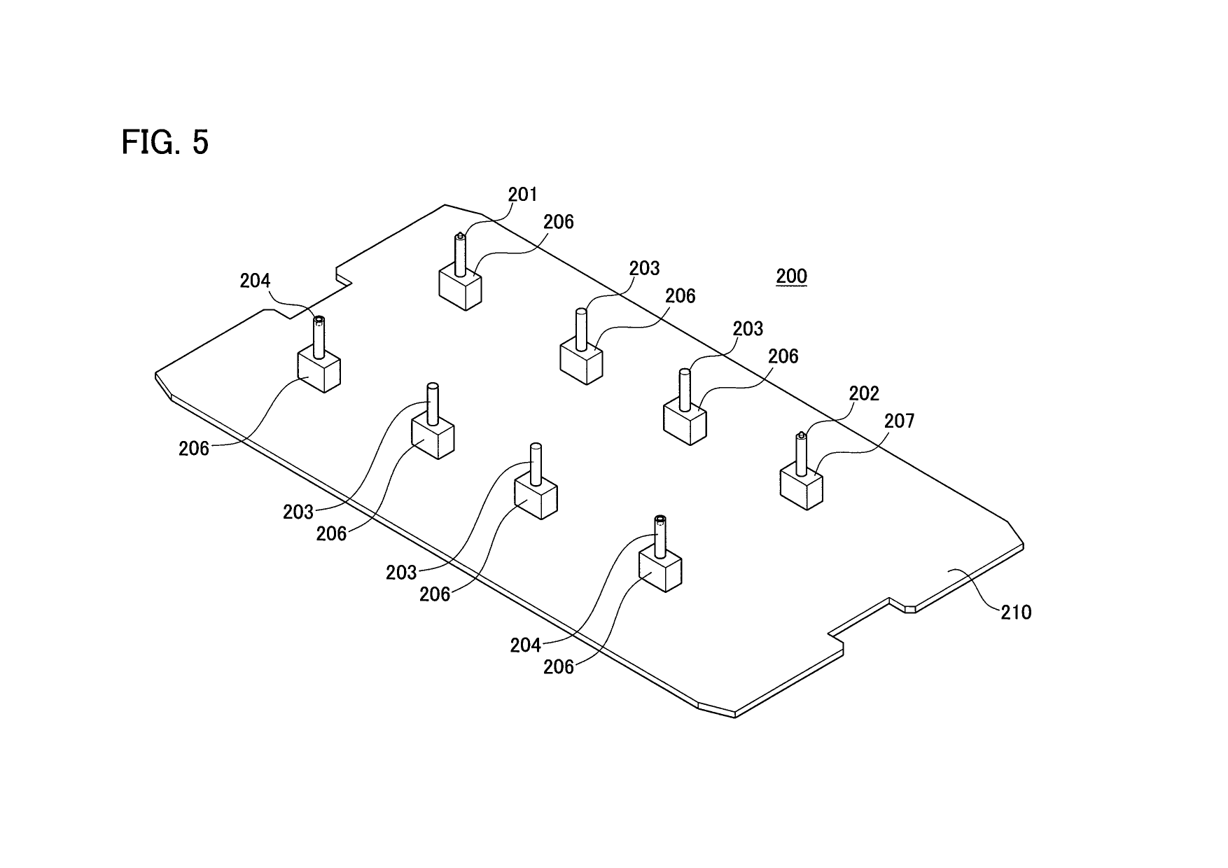

FIG. 5 is a perspective view of a pallet 200. A base 210 of the pallet 200 is formed of a resin plate member with a size of about 1100 mm×600 mm and a thickness of about 30 mm. On this base 210, blocks 206 are provided in which a primary positioning pin 201, seat pins 203, and a pin 204 formed with a dowel receiving hole are inserted. In a movable block 207, a secondary positioning pin 202 is inserted.

The primary positioning pin 201 and the secondary positioning pin 202 are locating pins each having a stepped shape formed with a support part 201b as a root, such that a cylindrical pin having a diameter of 14 mm is formed with a tip portion 201a having a diameter of 6 mm. Each seat pin 203 is a pin having a diameter of 14 mm. Each pin 204 with the dowel receiving hole is formed, at its top having a diameter of 14 mm, with a hole with a diameter of 8 mm. This hole serves to receive a dowel not shown attached to an end plate 101. The tip portion 201a should preferably be 6 mm or more in diameter to prevent breakage. The dowel not shown protrudes through the lower case 110 and hence the pin 204 is designed to prevent interference with the dowel. Those primary positioning pin 201, secondary positioning pin 202, seat pins 203, and pins 204 with dowel receiving holes are made of high-abrasion-proof metal and configured to be replaceable with respect to the blocks 206 and the movable block 207.

The movable block 207 is configured to be moved or shifted together with the secondary positioning pin 202 on the base 210. The movable block 207 is fixed and located in place with a bolt, a positioning pin, etc. not shown, to the base 210 so that the block 207 is positioned in a predetermined location.

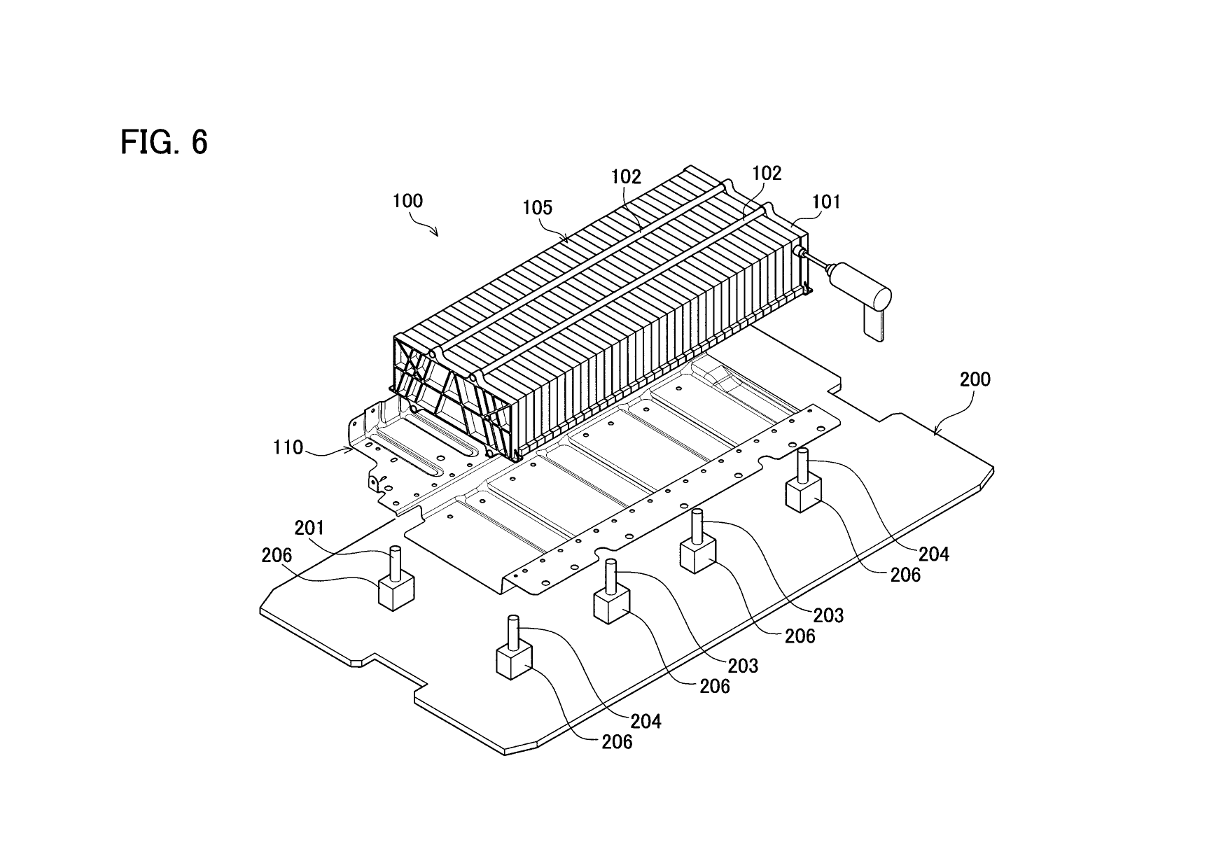

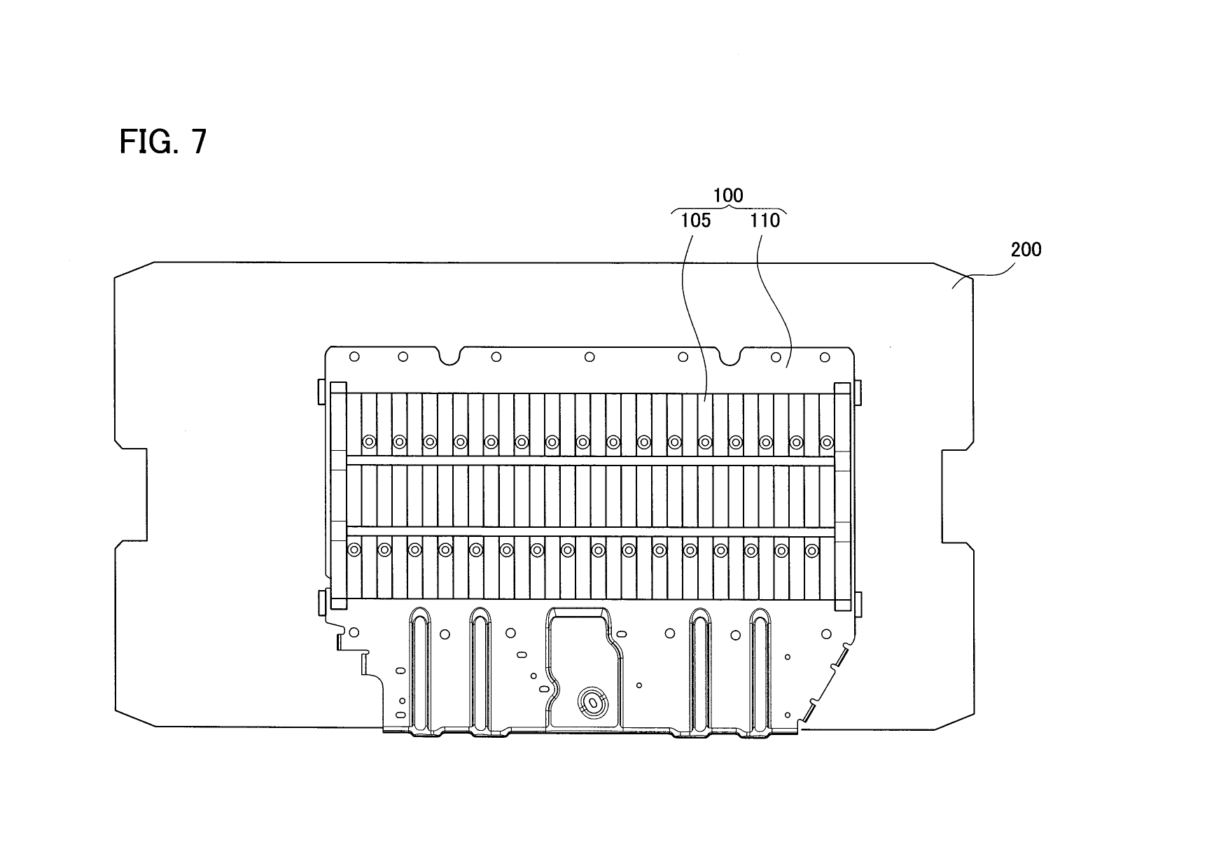

FIG. 6 is a perspective view showing a state where the battery unit 100 is being assembled onto the pallet 200. FIG. 7 is a plan view showing a state where the battery unit 100 is placed on the pallet 200. The battery unit 100 is mounted on the work-A lower case 110 supported by the primary positioning pin 201, secondary positioning pin 202, seat pins 203, and pins 204 with dowel receiving holes, which are provided on the base 210. Tip portions of the primary positioning pin 201 and the secondary positioning pin 202 are inserted in the end plates 101 of the battery unit 100 to position the end plates 101 in place. Further, the dowels not shown provided in the end plate 101 extend through the dowel holes 113 and inserted in the receiving holes formed in the pins 204.

The stepped seat portions of the primary positioning pin 201 and secondary positioning pin 202, the top portion of each seat pin 203, and the top portion of each pin 204 with a dowel receiving hole receive and support a lower surface of the work-A lower case 110.

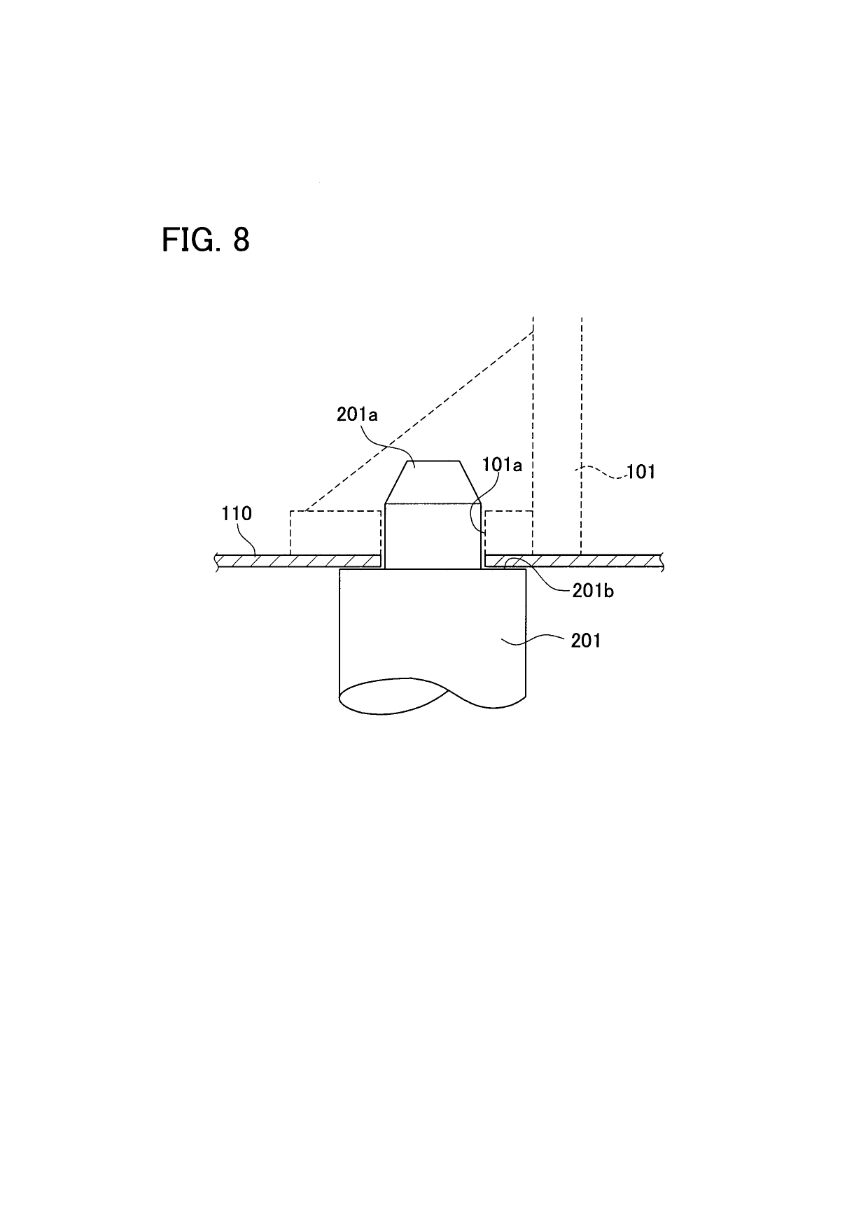

FIG. 8 is a cross sectional view of a part of a positioning pin. The primary positioning pin 201 is formed with the tip portion 201a and the support part 201b as mentioned above. The tip portion 201a of the pin 201 is inserted and positioned in the positioning hole 101a of the end plate 101 by passing through the positioning hole 111 for primary positioning pin in the work-A lower case 110. The secondary positioning pin 202 has the same configuration as the primary positioning pin 201.

As above, the work-A lower case 110 is placed on the pallet 200 and then the stack assembly 105 is installed. Thus, the battery unit 100 is completed.

Specifically, while the lower case 110 is placed on the pallet 200, the stack assembly 105 is attached to the lower case 110, and then the lower case 110 and the stack assembly 105 are fixed with bolts.

Thereafter, the stack assembly 105 is wired to form the battery unit 100. The battery unit 100 is then subjected to charge/discharge checks. As above, the battery unit 100 is made up and removed from the pallet 200.

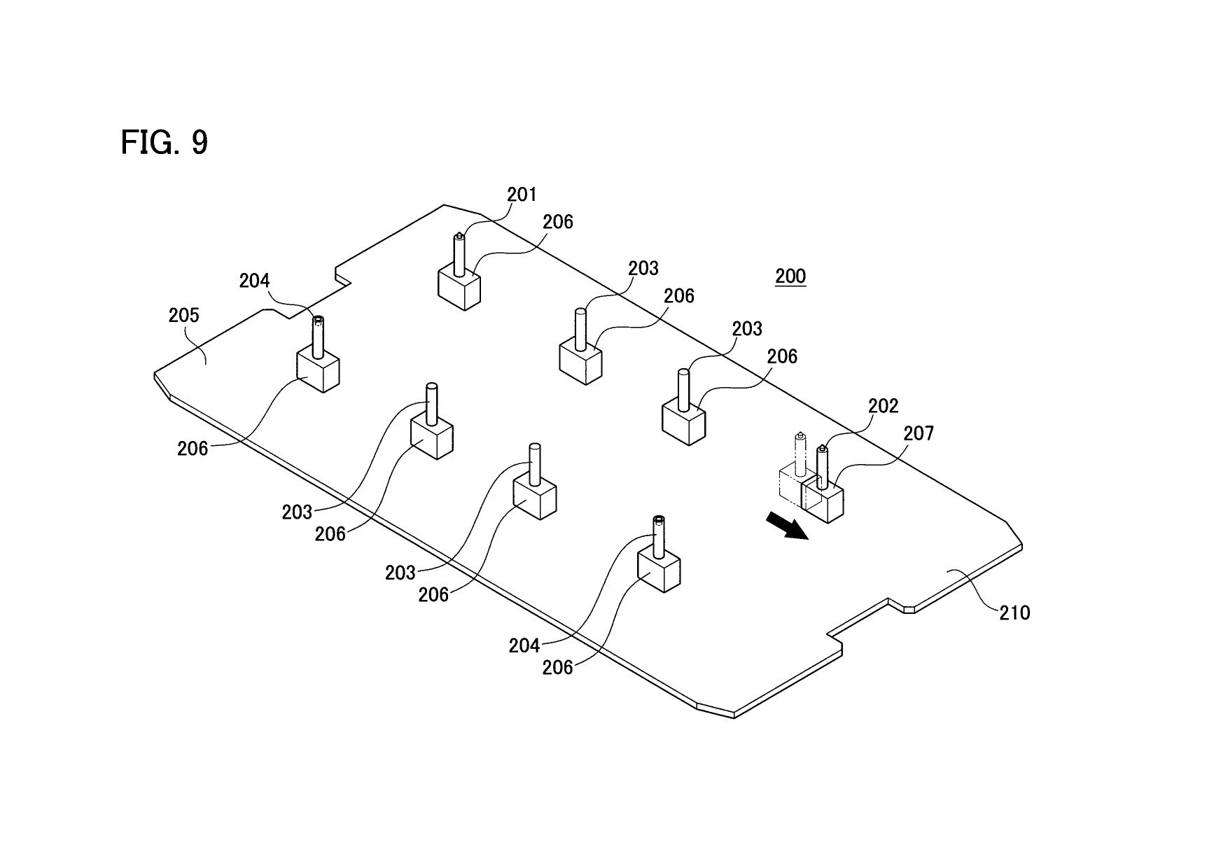

FIG. 9 is a perspective view of the pallet 200 after tooling change. The secondary positioning pin 202 and the movable block 207 provided in the pallet 200 are able to be moved or shifted on the base 210. To be concrete, the movable block 207 is insertable into the base 210. The base 210 is formed with a plurality of holes for allowing the tooling change.

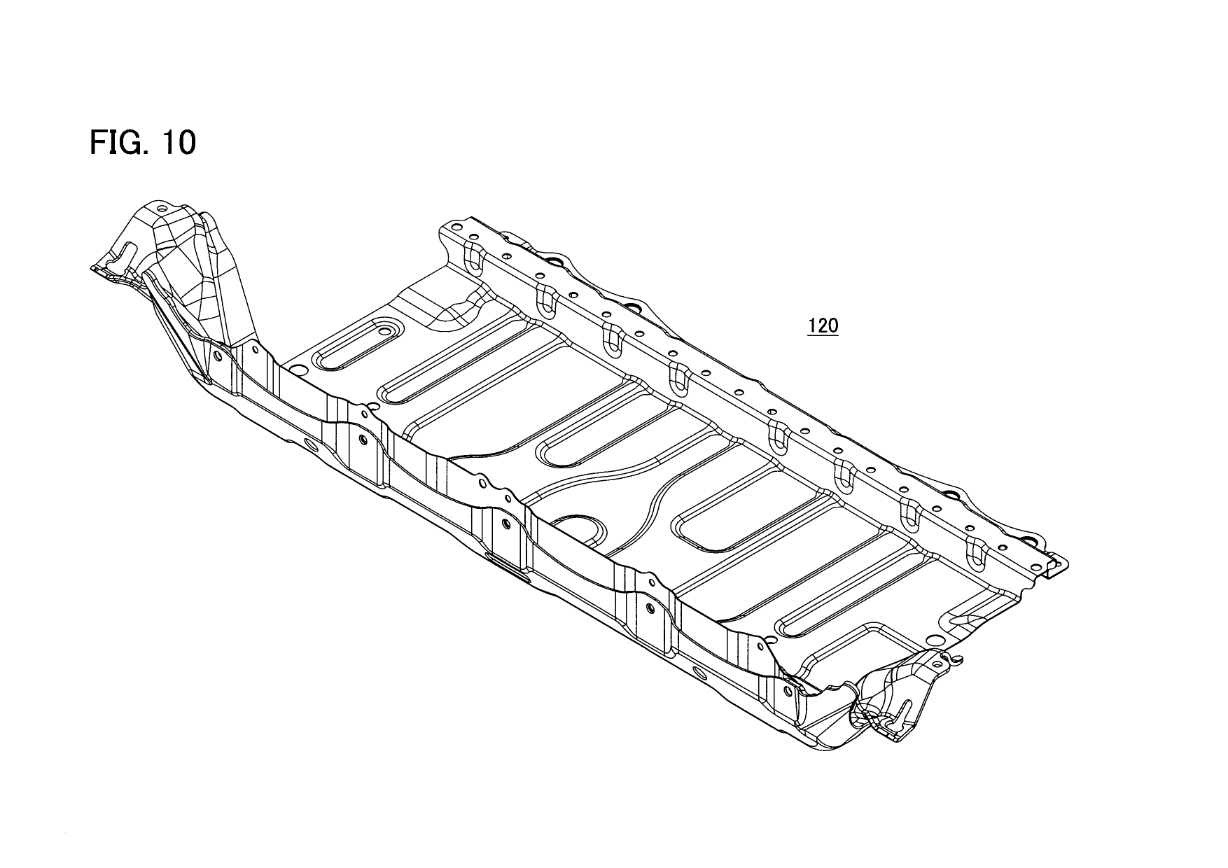

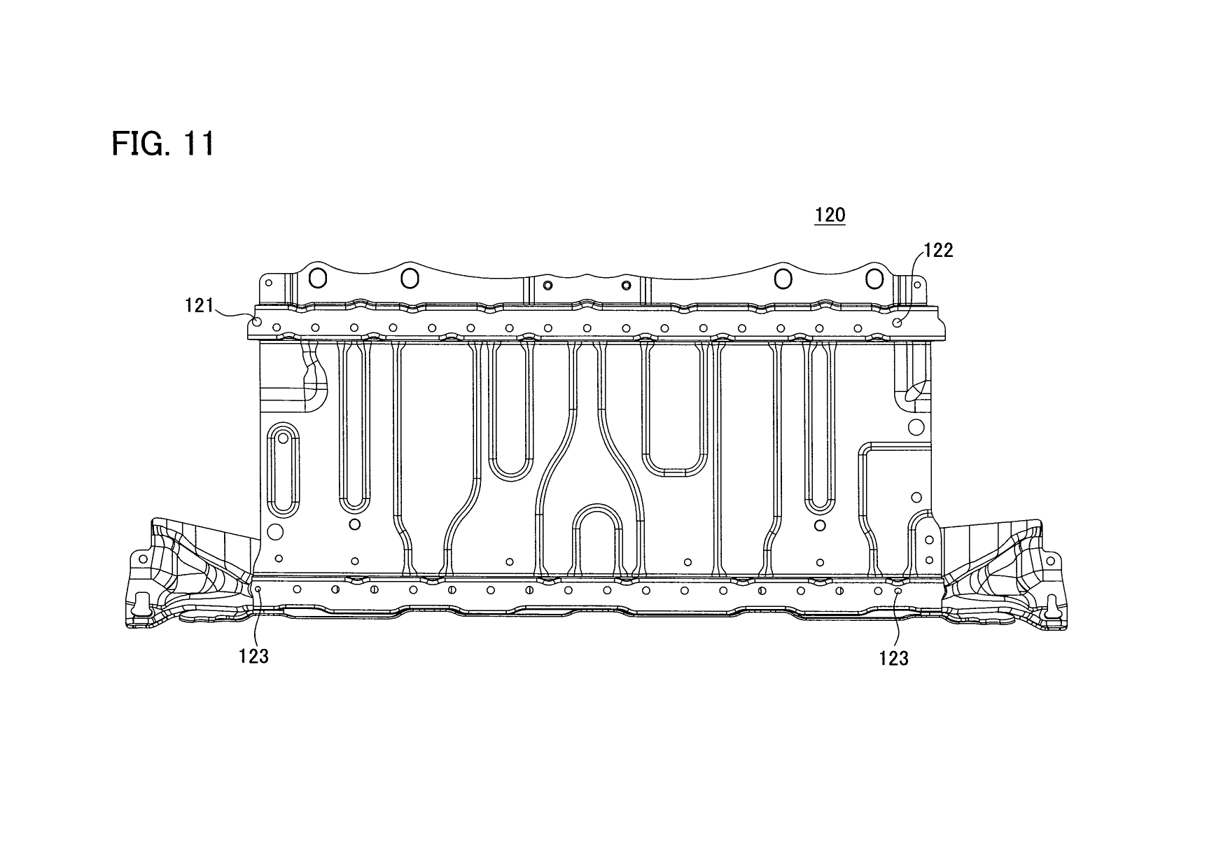

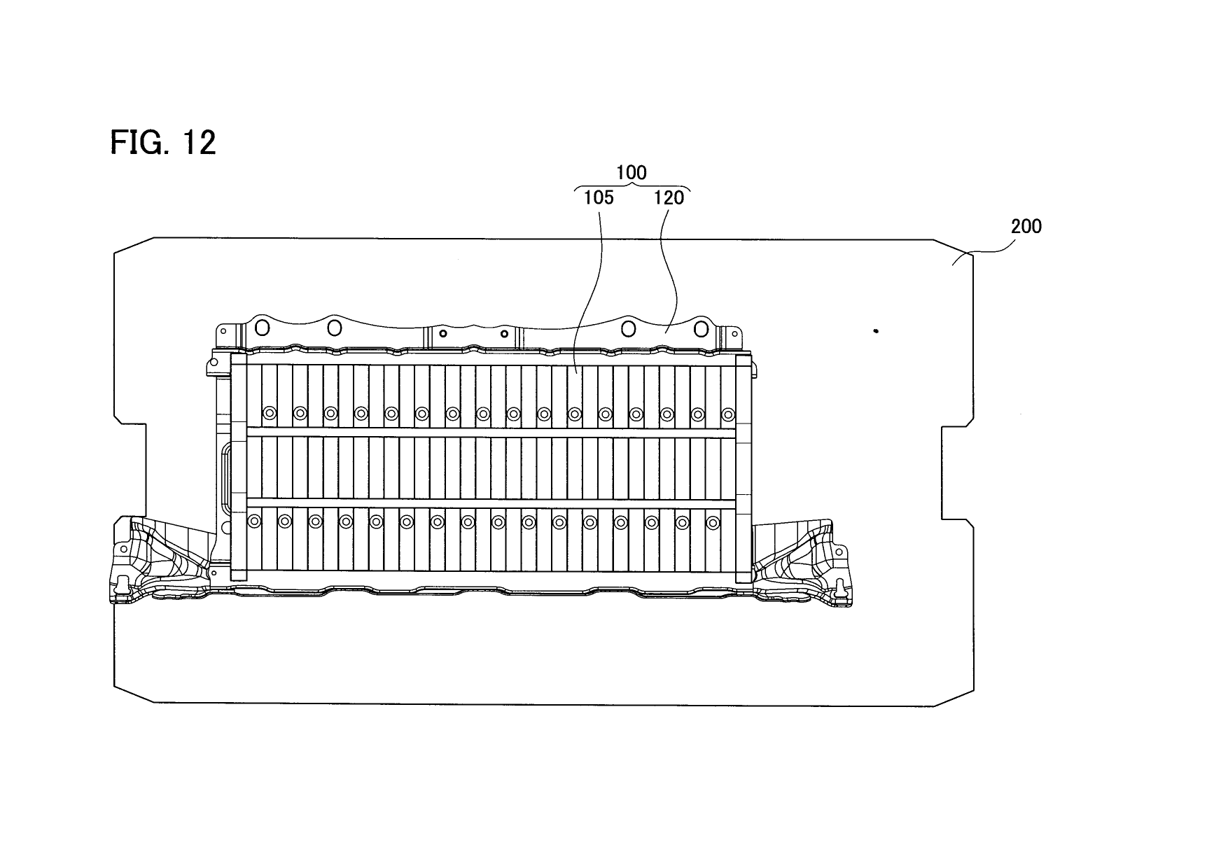

FIG. 10 is a perspective view of a lower case 120 for a work B (a “work-B lower case”). FIG. 11 is a plan view of the lower case 120. FIG. 12 is a plan view showing that the battery unit 100 is placed on the pallet 200.

The work-B lower case 120 is used, similar to the work-A lower case 110, to hold the stack assembly 105 but has a different shape from the work-A lower case 110. The work-B lower case 120 is provided with a positioning hole 121 for a primary positioning pin (“a primary positioning hole”), a positioning hole 122 for a secondary positioning pin (“a secondary positioning hole”), and dowel holes 123, as with the work-A lower case 110. On the work-B lower case 120, the stack assembly 105 having the same size as that mounted on the work-A lower case 110 is mounted.

Accordingly, even though the work-A lower case 110 and the work-B lower case 120 are different in shape from each other, manufacturing of the battery units 100 can be performed without needing tooling change between a condition for producing the battery unit 100 including the work-A lower case 110 and a condition for producing the battery unit 100 including the work-B lower case 120.

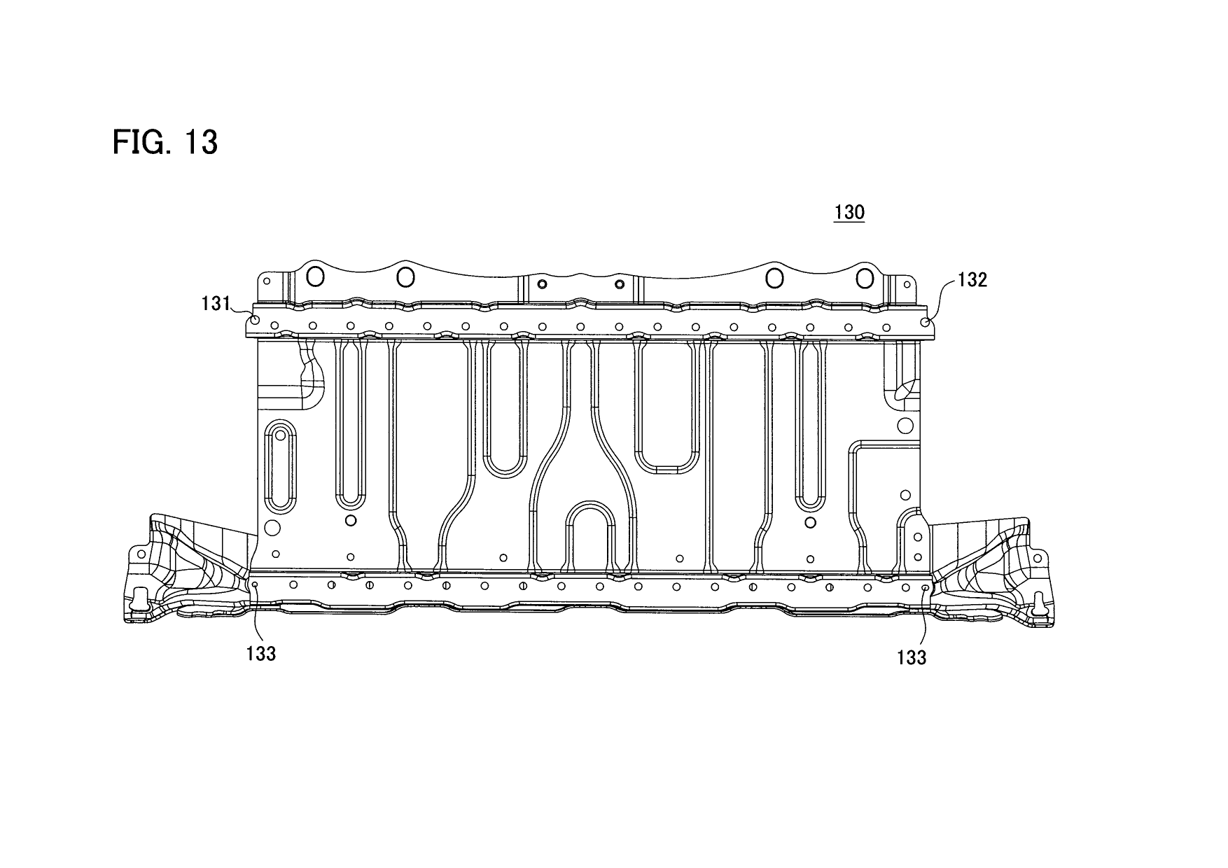

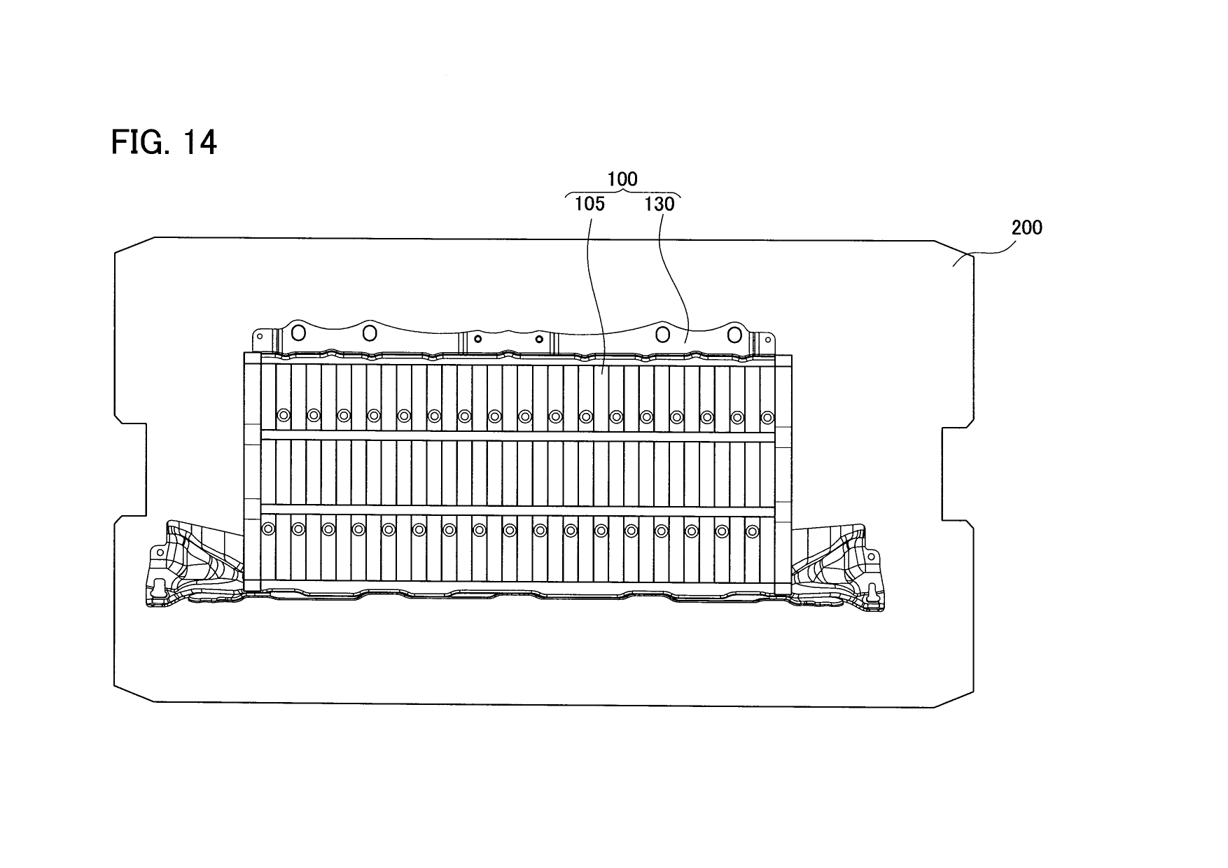

FIG. 13 is a plan view of a lower case 130 for a work C (a “work-C loser case”). FIG. 14 is a plan view showing that the battery unit 100 is placed on the pallet 200. The work-C lower case 130 is very similar in shape to the work-B lower case 120 and therefore a perspective view of the lower case 130 is omitted. The work-C lower case 130 is different from the work-B lower case 120 in that the secondary positioning pin 202 and the movable block 207 are shifted according to a difference in length between the stack assemblies 105.

As seen from comparison between FIG. 14 and FIG. 12, the positions of the battery units 100 placed on the pallets 200 are also different from each other. The number of battery cells 103 of the stack assembly 105 mounted on the work-C lower case 130 is 34. Accordingly, the position of the secondary positioning pin 202 and the movable block 207 of the work-C lower case 130 is not the same those of the work-A lower case 110 and the work-B lower case 120. Thus, tooling change is required.

However, the size of each battery cell 103 constituting the stack assembly 105 is equal and the number of stacked battery cells 103 is different from those mounted on the work-A lower case 110 and the work-B lower case 120. The stack assembly 105 in the work-C lower case 130 is therefore merely longer sideways (in a battery cell-stack direction). The shape of the end plates 101 is common. The number of battery cells 103 of the stack assembly 105 mounted on each of the work-A lower case 110 and the work-B lower case 120 is 32. On the other hand, the number of battery cells 103 of the stack assembly 105 mounted on the work-C lower case 130. It is accordingly necessary to design the work-C lower case 130 longer than the work-A lower case 110.

Accordingly, the secondary positioning pin 202 and the movable block 207 are shifted by tooling change as shown in FIG. 9 to correspond to the primary positioning hole 131 and the secondary positioning hole 132 in the work-C lower case 130. This enables an operation using the base 210 to assembly the stack assembly 105 to the work-C lower case 130. The battery unit 100 is thus placed on the pallet 200 as shown in FIG. 12.

The above manufacturing method of the battery unit 100 of the first embodiment can provide the operations and effects mentioned below.

One of the effects is to enable the commonality of pallet. The pallet 200 used for the battery unit 100 of the first embodiment is a secondary-battery assembling pallet for a secondary battery including the end plates 101 placed on both sides of the plurality of battery cells 103 arranged side by side and the work-A lower case 110 for attaching the battery cells 103 to a vehicle body. This pallet includes the positioning pins for positioning the end plates 101, the seat pins 203 for supporting the end plates 101 and the stack assembly 105 of the secondary battery, and the base 210. The positioning pin includes the primary positioning pin 201 and the secondary positioning pin 202. The primary positioning pin 201 is fixed to the base 210 and the secondary positioning pin 202 is held on the base 210 so that the pin 202 is able to be moved or shifted relative to the primary positioning pin 201.

The primary positioning pin 201 and the secondary positioning pin 202 are inserted respectively in the positioning holes 101a formed in the end plates 101, thereby setting the position of the battery unit 100 in place. The stack assemblies 105 each consisting of the battery cells 103 arranged side by side are different only in the size in the stacking direction of the battery cells 103. By changing the position of the secondary positioning pin 202 with respect to the primary positioning pin 201, a plurality of types of battery units 100 can be treated. Accordingly, a single pallet 200 can be used for a plurality of types of battery units 100 and thus can provide an advantage in costs.

When many types of pallets 200 are used in a line, a space or room for storing the pallets 200 is necessary, resulting in an increase in installation area of facility. Further, an additional operation of replacing the pallets 200 is required. If the battery units 100 of randomly selected types are to be manufactured, therefore, the lead time is inevitably made longer.

For achieving a manufacturing system of the applicant that intends to minimize the stocks, it is necessary to randomly supply the battery units 100 in a single line. Lot production is thus poor in productivity. The applicant investigated and found that lot production deteriorated the productivity by about 4.5%. It is therefore necessary to enable the commonality of a pallet 200 among many types of products. The use of the pallet 200 in common according to the present invention can greatly contribute to a cost reduction of the battery unit 100.

The primary positioning pin 201, secondary positioning pin 202, seat pins 203, and pins 204 each having a dowel receiving hole, which are removably held on the pallet 200, support thereon the work-A lower case 110, work-B lower case 120, or work-C lower case 130. This configuration enables increase the service life of the pallet 200. The primary positioning pin 201, secondary positioning pin 202, seat pins 203, and pins 204 each having a dowel receiving hole are made of high-abrasion-proof components, contributing to an increase in life of the pallet 200.

Since the primary positioning pin 201 is of a stepped shape including the tip portion 201a and the support part 201b, the primary positioning pin 201 can also serve as a seat pin 203 to support the work-A lower case 110 or others and can reduce the mounting space on the pallet 200. The same configuration applies to the secondary positioning pin 202. When the secondary positioning pin 202 is shifted by tooling change, the support seat is also shifted. Thus, a troublesome operation for tooling change is reduced. The secondary positioning pin 202 also functions as a failsafe device. Consequently, it is possible to enhance the production efficiency of the battery unit 100.

A second embodiment of the present invention will be described below. The second embodiment is almost identical to the first embodiment but slightly different in a manner of tooling change of the pallet 200. This difference is explained below.

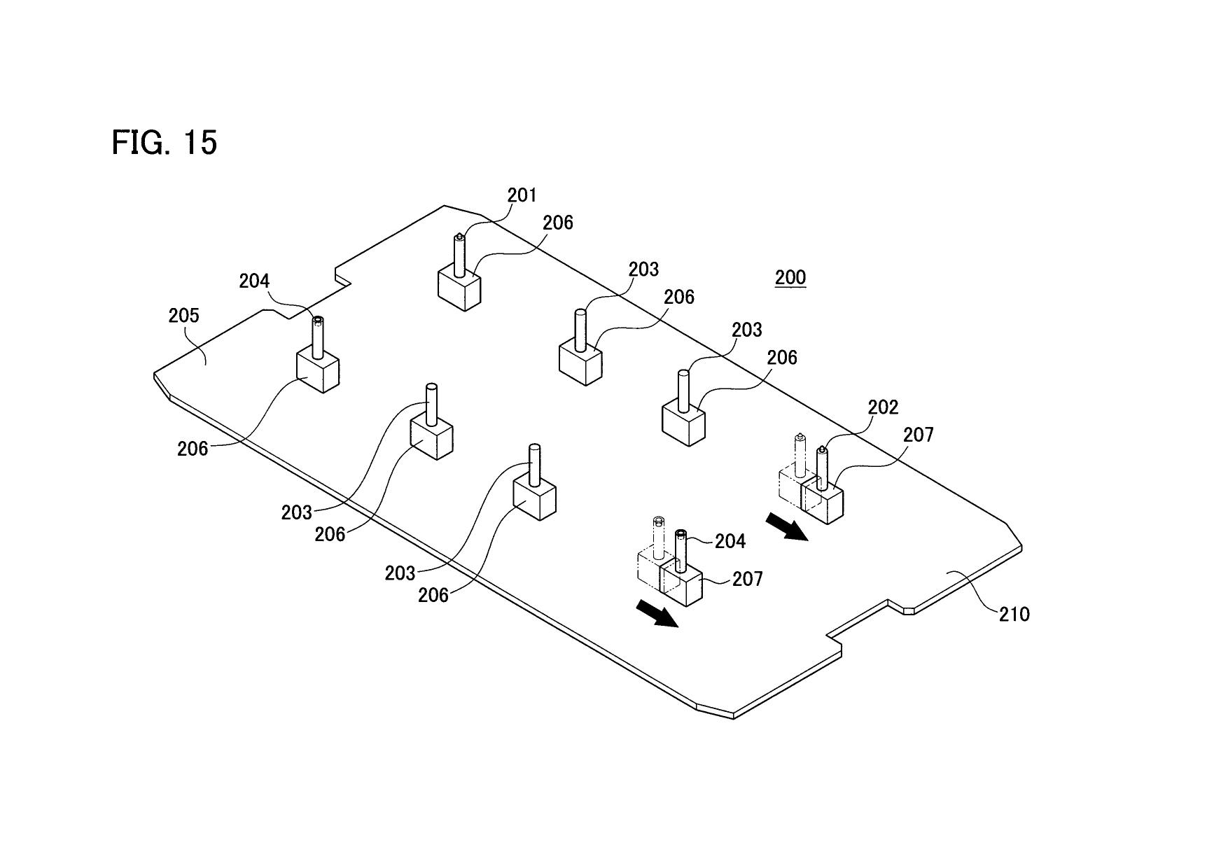

FIG. 15 is a perspective view of a pallet 200 of the second embodiment. The secondary positioning pin 202 and the movable block 207 provided on the pallet 200 are configured to be moved or shifted on the base 210. Further, the pin 204 formed with a dowel receiving hole, inserted in the movable block 207, is also configured to be moved or shifted on the base 210. The movable block 207 is identical in structure to that of the first embodiment and therefore will be moved by tooling change.

Since the pin 204 is also movable or shiftable, more types of battery units 100 can be treated. If the secondary positioning pin 202 and the pin 204 with a dowel receiving hole do not need to be moved so much, the pin 204 can support a portion near the end plate 101. Thus, even if tooling change is not performed, no large problem will occur.

However, according to the size of the battery unit 100, there may be a case where the pins 202 and 204 are moved to the positions at which they may cause the lower case to warp or bend, that is, the pin 204 of the pallet 200 is not appropriate to support the battery unit 100. Accordingly, there is a case where the pin 204 with a dowel receiving hole is more preferably configured to be movable.

The present invention is explained in the above first and second embodiments but is not limited thereto. The invention may be embodied in other specific forms without departing from the essential characteristics thereof.

For instance, the tooling change positions of the secondary positioning pin 202 and the movable block 207 are set to two locations for achieving the commonality of the battery unit 100. Alternatively, three or more tooling change positions may be adopted for treating more types of products. Not only the pin 204 with a dowel receiving hole in the second embodiment but also the seat pins 203 may be configured to be changed in position. However, more tooling change operations increase lead time and thus all the commonality possible should be more preferable. Further, the materials and the sizes exemplified above may be changed within a range of design matters.

### DESCRIPTION OF THE REFERENCE SIGNS

100 Battery unit
101 End plate
101a Positioning hole
102 Binding metal fitting
103 Battery cell
105 Stack assembly
110 Lower case for work A
111 Positioning hole for primary positioning pin
112 Positioning hole for secondary positioning pin
113 Dowel hole
120 Lower case for work B
121 Positioning hole for primary positioning pin
122 Positioning hole for secondary positioning pin
123 Dowel hole
130 Lower case for work C
131 Positioning hole for primary positioning pin
132 Positioning hole for secondary positioning pin
200 Pallet
201 Primary positioning pin
201a End portion
201b Support part
202 Secondary positioning pin
203 Seat pin
204 Pin with dowel receiving hole
206 Block
207 Movable block
201 Base

1. An assembling pallet for a secondary battery including end plates placed on both sides of a plurality of battery cells arranged side by side and a lower case for mounting the battery cells on a vehicle body, wherein
the pallet includes a positioning pin for positioning the end plates, a support seat for supporting the end plates and a stack assembly of the secondary battery, and a base plate,
the positioning pin includes a primary positioning pin and a secondary positioning pin, the primary positioning pin is fixed to the base plate, and the secondary positioning pin is held on the base plate and configured to be movable relative to the primary positioning pin.

2. The assembling pallet for a secondary battery according to claim 1, wherein the primary positioning pin and the secondary positioning pin are formed in a stepped shape, each pin including a tip portion for positioning the end plates and a support part for supporting the lower case,
the support part is formed with a height equal to the support seat, and
the primary positioning pin, the secondary positioning pin, and the support seat are inserted and placed in the base plate.

3. A method of manufacturing a secondary battery by placing a lower case on an assembling pallet, and placing a stack assembly on the lower case, the stack assembly consisting of a plurality of battery cells arranged side by side and bound from both sides with end plates, and assembling the lower case and the stack assembly, the method comprising:
disposing a secondary positioning pin configured to be movable relative to a primary positioning pin provided in the assembling pallet, in a position corresponding to a position of one of the end plates of the stack assembly,
supporting the lower case by the primary positioning pin, secondary positioning pin, and support seat, and
placing the stack assembly on the lower case and assembling the stack assembly and lower case.
